(19) United States
(12) Patent Application Publication
(10) Pub. No.: US 2007/0052186 A1
(43) Pub. Date: Mar. 8, 2007

(54) THE PORTABLE WHEELED SHOPPING BIN SYSTEM

(75) Inventor: Jan Wodzislaw Bobrowski, North Vancouver (CA)

Correspondence Address: Mr.Jan Wodzislaw Bobrowski, 990 Doran Road, North Vancouver, V7K1M5, CA

(73) Assignee: Jan Wodzislaw Bobrowski, North Vancouver (CA)

(21) Appl. No.: 11/162,244

(22) Filed: Sep. 2, 2005

(51) Int. Cl. B62B 7/12

(52) U.S. Cl. 280/30

(57) ABSTRACT

In accordance with this invention a portable wheeled shopping bin system that may be owned by a shopper and is capable of safe pulling or pushing loads through a complete process of shopping and carrying the load home is described. The portable wheeled shopping bin system is simple, easy to use and fully conforms to any existing security system implemented in the stores. The portable wheeled shopping bin system comprises a bin permanently equipped with a pair of rear wheels, a pair of front supporting legs, the securing expandable net that may be hooked over the top of the bin, the retracting handle with an optional lock, and the reflecting safety strips placed on the contour of the bin.

### FIELD OF THE INVENTION

The present invention relates to carts, and more particularly to a cart that is intended for use while shopping and carrying cargo home by car or for pedestrians shopping in the neighborhood, to facilitate the convenient and safe transportation of relatively low to medium loads in urban environment.

### DESCRIPTION OF THE PRIOR ART

There are few carrying devices designed for shoppers that support the load and are convenient both for the shoppers and the stores. There are low to medium load shopping baskets owned by a store made of plastic or wire designed for carrying by hand, heavy load shopping carts on four wheels to be pushed, and a selection of collapsible or solid medium load shopping carts supported by two or four wheels that are owned by shoppers. There are some concepts of carts that can be owned by shoppers that are designed for carrying the cargo placed in hanging plastic shopping bags.

None of the existing devices that are designed for shoppers' ownership and operation was based on a modified common lightweight plastic shopping basket equipped with wheels, supporting legs and a retractable handle, where the cargo stacked in a bin can be secured with a net. None of the existing devices was designed for safe operating on parking lots (most of heavy load buggies tend to wander on the lot) neither to be safely used by neighborhood shoppers who walk the cargo home.

In view of the foregoing disadvantages inherent in the known type shopping carts now present in the prior art, the present invention provides an improved cart, which will be described subsequently in great detail, is to provide a new and improved cart which is not anticipated, rendered obvious, suggested, or even implied by the prior art, either alone or in any combination thereof.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the portable wheeled shopping bin system constructed in accordance with the principles of the present invention where the handle is expanded;

FIG. 2 is a side view of the portable wheeled shopping bin system of the present invention where the handle is retracted.

### DETAILED DESCRIPTION OF THE PREFERRED EMBODIMENT

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

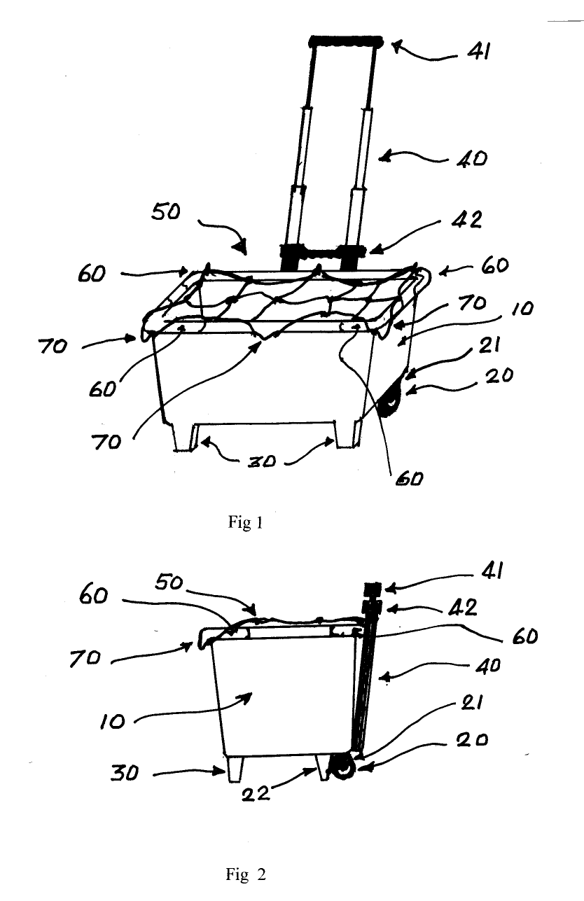

Referring now to the drawings, and in particular FIGS. 1 and 2 thereof, one preferred embodiment of the present invention is shown and generally designated by the reference numeral 10. The present invention of the portable wheeled shopping bin system comprises a bin 10 that utilizes denominations of a plastics or wire shopping baskets commonly used in stores and a pair of wheel housings 21 attached to or being an integral part moulded within the rear part of the bottom panel of the bin and a pair of supported back wheels 20 attached to the housing 21 and an optional pair of rear supporting legs 22 constituting an integral part of the wheel housing and a pair of front supporting legs 30 level the bin when it is in a rest position and a tubular telescoping handle assembly 40 comprising a telescoping three or four piece tubular assembly supported by each of the mainframe tubular members comprising of the upper ends of the three or four piece tubular assemblies are joined by a towing grip 41, the bottom tubular assemblies are joined by a carrying handle 42, and the tubular members of the three or four piece tubular assemblies are optionally provided with locking mechanism that locks the handle assembly in its extended or retracted positions, hooks 70 attached under the brim or being moulded as a part of the brim that secure the net 50 when it is expanded over the bin opening, an elastic net 50 permanently tied to the rear brim of the bin that may be expanded and looped to the hooks 70 to secure the cargo placed in the bin 10 and highlighting and reflecting safety strips 60 marked on the brim or on a contour of the bin.

What is claimed is:

1. A wheeled shopping bin allowing a user to securely pull or push a cargo over the complete process of shopping and carry the cargo home by allowing the user to exert a pulling or pushing force onto said wheeled shopping bin by engaging the user's hand to the telescopic handle of the said wheeled shopping bin, said wheeled shopping bin comprising:
a bin that utilizes denominations of a plastics or wire shopping baskets commonly used in stores; and
a pair of wheel housings attached to or being an integral part formed within the rear part of the bottom panel of the bin; and
a pair of supported back wheels attached to the housing; and
an optional pair of rear supporting legs, constituting an integral part of the wheel housing; and
a pair of front supporting legs leveling the bin when it is in a rest position where the legs and wheels being located on the bottom panel possibly closest to its front and back corners; and
a tubular telescoping handle assembly comprising a telescoping three or four piece tubular assembly supported by each of the mainframe tubular members comprising of;
the upper ends of the three or four piece tubular assemblies are joined by a grip; and
the tubular members of the three or four piece tubular assemblies are provided with locking mechanism that locks the handle assembly in its extended or retracted positions; and
the handle assembly may carry a single release bar switch able between a normal locked position and a depressed, unlatching position;
when the bar is shifted from its normal locked position to its unlatching position by the bin operator's hand or foot, the telescoping handle assembly can be shifted from its retracted to its extended to position or be retracted to its resting position;
hooks attached under the brim, or being formed as a part of the brim, located on the front and the side panels, that secure the net when it is expanded over the bin opening; and
an elastic net tied to the rear brim of the bin that may be expanded and looped to the hooks to secure the cargo placed in the bin; and
highlighting and reflecting safety strips marked on the brim.
